(19) United States
(12) Patent Application Publication
(10) Pub. No.: US 2009/0104085 A1
(43) Pub. Date: Apr. 23, 2009

(54) REDUCING AGENT SPRAY CONTROL SYSTEM ENSURING OPERATION EFFICIENCY

(75) Inventor: Ataru ICHIKAWA, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/254,280

(22) Filed: Oct. 20, 2008

(30) Foreign Application Priority Data
Oct. 19, 2007 (JP) 2007-271983

(51) Int. Cl. B01D 53/92

(52) U.S. Cl. 422/112

(57) ABSTRACT

A reducing agent spray control system designed to control an exhaust emission control device such as a urea SCR device for automotive internal combustion engines. The exhaust emission control device includes an injector injecting a spray of a reducing agent into an exhaust pipe of the engine to reduce a selected component such as NOx in exhaust gas to purify the exhaust gas and a pump regulating the pressure of the reducing agent to be sprayed by the injector. The system works to control the pump so as to bring the pressure of the reducing agent to be sprayed by the injector into agreement with a target value, as determined based on the state of the exhaust gas, to ensure the efficiency of purification of the exhaust gas without sacrificing the service life of the pump.

### CROSS REFERENCE TO RELATED DOCUMENT

The present application claims the benefit of Japanese Patent Application No. 2007-271983 filed on Oct. 19, 2007, the disclosure of which is incorporated herein by reference.

### BACKGROUND OF THE INVENTION

1. Technical Field of the Invention

The present invention relates generally to a reducing agent spray control system which may be employed with an SCR (Selective Catalytic Reduction) system for automotive internal combustion engines which works as an exhaust emission control device to spray a reducing agent such as a urea aqueous solution to induce an exhaust gas purification reaction.

2. Background Art

Urea SCR systems are now being developed which are designed as exhaust emission control systems for automotive internal combustion engines such as diesel engines to use a reducing agent such as a urea aqueous solution to convert NOx (nitrogen oxide) contained in exhaust gas into harmless or less harmful products effectively. For example, a Japanese Patent First Publication No. 2003-293739 discloses such a type of urea SCR system.

The urea SCR system, as taught in the above publication, is equipped with a catalyst facilitating an exhaust emission purification reaction, an exhaust pipe through which exhaust gas, as emitted from the engine, flows to the catalyst, and a nozzle installed in the exhaust pipe to inject a urea aqueous solution into the exhaust pipe. The nozzle is connected to a urea solution supplying device and an air pump and works to produce and inject a spray of a mixture of the urea aqueous solution, as delivered from the urea solution supplying device, and compressed air, as fed from the air pump, into the exhaust pipe. The catalyst serves to facilitate the reduction reaction of NOx contained in the exhaust gas with ammonia produced by the hydrolysis of the urea aqueous solution. Specifically, the urea aqueous solution (containing the hydrolyzed ammonia), as sprayed by the nozzle, is carried downstream to the catalyst with the aid of a flow of the exhaust gas and then induces the reduction reaction of the NOx with the ammonia in the catalyst to purify the exhaust gas.

The above type of urea SCR system may be designed to elevate the pressure of the compressed air to enhance the atomization of the spray of the urea aqueous solution for accelerating the reduction reaction of NOx with ammonia to improve the efficiency of purification of the exhaust gas. The elevation of the pressure of the compressed air will, however, result in an increased physical load on the air pump which leads to a decrease in service life thereof.

### SUMMARY OF THE INVENTION

It is therefore a principal object of the invention to avoid the disadvantages of the prior art.

It is another object of the invention to provide a reducing agent spray control system which controls an exhaust emission control device working to spray a reducing agent into an exhaust pipe of an internal combustion engine to induce a reduction reaction of a selected component of the exhaust gas with the reducing agent for converting the selected component into a harmless product and which is designed to ensure the efficiency of purification of the exhaust gas without sacrificing the service life of the exhaust emission control device.

According to one aspect of the invention, there is provided a reducing agent spray control system designed to control an operation of an exhaust emission control device such as a urea SCR (Selective Catalytic Reduction) device for automotive internal combustion engines. The exhaust emission control device includes an injector working to inject a spray of a reducing agent into an exhaust pipe of the engine to reduce a selected component of exhaust gas to purify the exhaust gas and a pump working to regulate a pressure of the reducing agent to be sprayed by the injector. The reducing agent spray control system comprises: (a) exhaust gas state parameter acquiring means for acquiring an exhaust gas state parameter associated with a state of the exhaust gas flowing through the exhaust pipe; and (b) control means for controlling an operation of the pump so as to bring the pressure of the reducing agent to be sprayed by the injector into agreement with a target value, as determined based on the exhaust gas state parameter, to control the spray of the reducing agent.

The velocity at which the selected component of the exhaust gas reacts with the reducing agent is regulated by controlling the pressure of the reducing agent to be sprayed into the exhaust pipe. Specifically, an increase in pressure of the reducing agent will result in enhanced atomization of the reducing agent sprayed by the injector into the exhaust pipe, thereby accelerating the reaction of the selected component with the reducing agent. Such efficiency of purification of the exhaust gas is found to change with a change in state of the exhaust gas. The control means is, therefore, designed to set the pressure of the reducing agent to be sprayed by the injector to the target value, as determined based on the state of the exhaust gas. For instance, when the exhaust gas state parameter indicates a higher possibility that the efficiency of purification of the exhaust gas has been reduced, the control means elevates the pressure of the reducing agent to accelerate the reaction of the selected component with the reducing agent. Alternatively, when the exhaust gas state parameter indicates a lower possibility that the efficiency of purification of the exhaust gas has been reduced, the control means decreases the pressure of the reducing agent, thereby reducing a load on the pump to ensure the service life of the pump.

In the preferred mode of the invention, the exhaust gas state parameter acquiring means acquires a temperature of the exhaust gas as representing the exhaust gas state. The control means determines the target value based on the temperature of the exhaust gas. Specifically, the control means regulates the pressure of the reducing agent to be sprayed by the injector as a function of the temperate of the exhaust gas.

The exhaust gas state parameter acquiring means may alternatively acquire a flow velocity of the exhaust gas as representing the exhaust gas state. The control means may determine the target value based on the flow velocity of the exhaust gas.

The exhaust gas state parameter acquiring means may alternatively acquire a quantity of the selected component of the exhaust gas as representing the exhaust gas state. The control means determine the target value based on the quantity of the selected component of the exhaust gas.

The exhaust gas state parameter acquiring means may alternatively acquire an operating condition of the internal combustion engine. When the operating condition represents one of facts that the internal combustion engine is being warmed up and that the internal combustion engine continues to idle over a given period of time, the control means may control the operation of the pump so as to bring the pressure of the reducing agent to be sprayed by the injector into agreement with the target value.

The selected component of the exhaust gas is a nitrogen oxide contained in the exhaust gas. The reducing agent is urea aqueous solution or ammonia. The exhaust emission control device also includes a catalyst installed in the exhaust pipe downstream of the injector to facilitate a reduction reaction of the nitrogen oxide with the reducing agent.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a schematic view which shows a urea SCR (Selective Catalytic Reduction) device according to the first embodiment of the invention;

FIG. 2 is a flowchart of a sequence of logical steps or program to be executed in the first embodiment to control the pressure of urea aqueous solution to be sprayed into an exhaust pipe of an internal combustion engine;

FIG. 3(a) is a view which demonstrates a change in temperature of exhaust gas;

FIG. 3(b) is a view which demonstrates a change in pressure of urea aqueous solution to be sprayed into the exhaust gas which is determined as a function of the temperature of the exhaust gas, as shown in FIG. 3(a), in the first embodiment;

FIG. 4 is a flowchart of a sequence of logical steps or program to be executed in the second embodiment to control the pressure of urea aqueous solution to be sprayed into an exhaust pipe of an internal combustion engine;

FIG. 5 is a flowchart of a sequence of logical steps or program to be executed in the third embodiment to control the pressure of urea aqueous solution to be sprayed into an exhaust pipe of an internal combustion engine;

FIG. 6 is a flowchart of a sequence of logical steps or program to be executed in the fourth embodiment to control the pressure of urea aqueous solution to be sprayed into an exhaust pipe of an internal combustion engine;

FIG. 7 is a flowchart of a sequence of logical steps or program to be executed in the fifth embodiment to control the pressure of urea aqueous solution to be sprayed into an exhaust pipe of an internal combustion engine; and

FIG. 8 is a partially schematic view which shows a urea SCR device according to the sixth embodiment of the invention.

### DESCRIPTION OF THE PREFERRED EMBODIMENTS

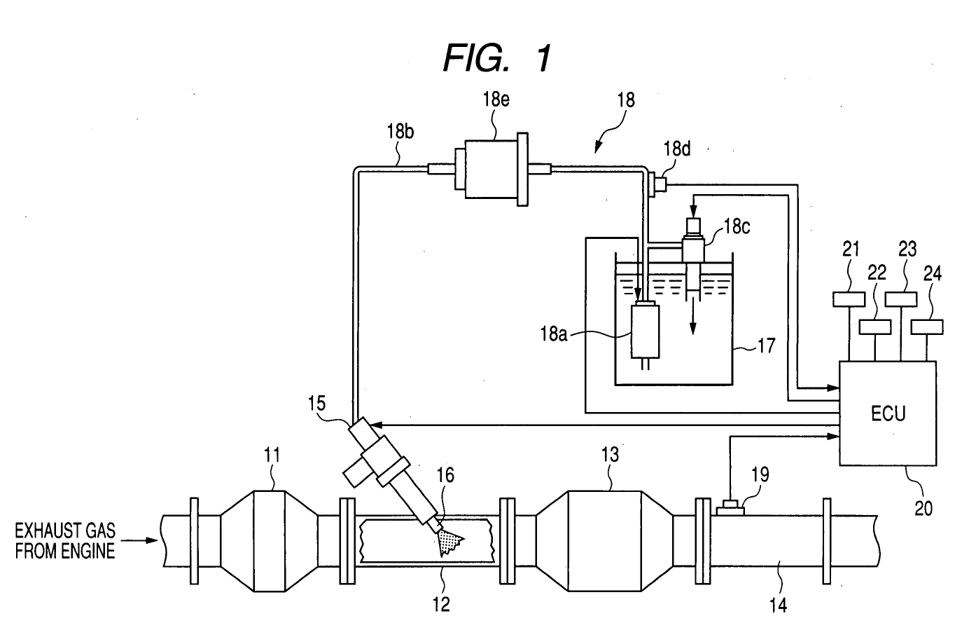

Referring to the drawings, particularly to FIG. 1, there is shown an exhaust emission control system for automotive diesel engines which is equipped with a urea SCR (Selectively Catalytic Reduction) device which is engineered as an exhaust emission control device to convert harmful emissions contained in exhaust gas from an automotive diesel engine (not shown) into harmless products. The urea SCR device includes a DPF (Diesel Particulate Filter) 11, an exhaust pipe 12, an SCR catalyst 13, and an exhaust pipe 14. The urea SCR device is installed on a lowermost stream end of an exhaust manifold connected to exhaust ports of the diesel engine.

The urea SCR device also includes a urea solution injector 15 installed in the exhaust pipe 12 to spray a urea aqueous solution (i.e., a reducing agent) into an exhaust path extending through the DPF 11, the exhaust pipe 12, the SCR catalyst 13, and the exhaust pipe 14.

The DPF 11 is a PM (Particulate Matter) filter which is regenerative continuously and works to collect or trap particulate matter in the exhaust gas. The particulate matters trapped in the DPF 11 are usually burned out by the post injection of fuel into the engine following the main injection to regenerate the DPF 11. The DPF 11 supports therein a platinum-based oxidation catalyst (not shown) and serves to remove HC and CO together with soluble organic fraction (SOF) that is one of particulate matters.

The urea solution injector 15 has a nozzle 16 in which a spray hole is formed. The urea solution injector 15 works to inject a spray of urea aqueous solution into the exhaust pipe 12 through the spray hole. The SCR catalyst 13 carries therein a catalytic metal such as vanadium oxide (V₂O₅) to facilitate the reduction of NOx. The spray of urea aqueous solution injected by the urea solution injector 15 into the exhaust pipe 12 is converted by the heat of the exhaust gas according to Eq. (1) below into ammonia (NH₃), which is then fed to the SCR catalyst 13 along with the exhaust gas. In the SCR catalyst 13, NOx is reduced by ammonia according to Eqs. (2) to (4) into less harmful or harmless products.

(NH₂)2CO+H₂O→2NH₃+CO₂ (1)

4NO+4NH₃+O₂→4N₂+6H₂O (2)

6HO₂+8NH₂→7N₂+12H₂O (3)

NO+NO₂+2NH₃→2N₂+3H₂O (4)

The urea solution injector 15 is supplied with the urea aqueous solution from a urea solution tank 17. Specifically, a pumping device 18 sucks the urea aqueous solution out of the urea solution tank 17 and feeds it to the urea solution injector 15. The pumping device 18 is made up of a pump 18a, a pipe 18b, a urea solution pressure regulator 18c, a urea solution pressure sensor 18d, and a filter 18e.

The pump 18a has installed therein an electric motor which works to pump the urea aqueous solution from the urea solution tank 17. The urea solution pressure regulator 18c, the urea solution pressure sensor 18d, and the filter 18e are installed in the pipe 18b extending from the pump 18a to the urea solution injector 15. The filter 18e works to filter the urea aqueous solution fed from the pump 18a to the urea solution injector 15. The urea solution pressure sensor 18d works to measure the pressure of the urea aqueous solution flowing through the pipe 18b (i.e., the pressure of the urea aqueous solution to be sprayed from the urea solution injector 15) and output a signal indicative thereof. The urea solution pressure regulator 18c works to regulate the pressure of the urea aqueous solution in the pipe 18b. Specifically, when the pressure of the urea aqueous solution in the pipe 18b exceeds a set level P1, the urea solution pressure regulator 18c drains the urea aqueous solution from the pipe 18b to the urea solution tank 17.

The exhaust pipe 14 has installed therein an exhaust gas sensor 19 in which a NOx sensor and an exhaust gas temperature sensor are built to measure the amount of NOx contained in the exhaust gas and the temperature of the exhaust gas.

The exhaust emission control system also includes an electronic control unit (ECU) 20 which functions as a reducing agent spray control device to handle an operation of the urea SCR device to control the state of a spray of the urea aqueous solution produced by the urea solution injector 15. The ECU 20 is equipped with a typical microcomputer which monitors outputs from an airflow meter 21, an accelerator position sensor 22, a crank angle sensor 23, a coolant temperature sensor 24 to actuate the urea solution injector 15 and the pump 18a for controlling the purification of the exhaust gas. Specifically, the ECU 20 controls an on-duration for which the urea solution injector 15 is kept opened and an injection timing at which the urea solution injector 15 is to be opened to supply a controlled quantity of the urea aqueous solution to the exhaust gas flowing through the exhaust pipe 12 at a controlled time.

The airflow meter 21 is installed in the intake pipe of the diesel engine to measure the flow rate of air charged into the diesel engine. The accelerator position sensor 22 is installed near the accelerator pedal of an automotive vehicle equipped with the exhaust emission control system and works to measure the position of the accelerator pedal (i.e., a driver's effort on the accelerator pedal that is a function of an open position of the throttle valve). The crank angle sensor 23 works to output a pulse signal in a cycle of, for example, 30° rotation of the crankshaft of the diesel engine. The coolant temperature sensor 24 works to measure the temperature of coolant for the diesel engine.

The exhaust emission control system is designed to elevate the pressure of the urea aqueous solution to be sprayed from the urea solution injector 15 to enhance the atomization of the urea aqueous solution in the exhaust pipe 12 in order to facilitate the reduction reaction of NOx with ammonia to improve the efficiency in purification of the exhaust gas. The elevation of the pressure of the urea aqueous solution to be sprayed from the urea solution injector 15, that is, the pressure of the urea aqueous solution discharged from the pumping device 18 will, however, result in an increase on load on the pump 18a which leads to a decreased service life of the pump 18a.

It is found that the efficiency of purification of the exhaust gas in the urea SCR device depends upon the temperature of the exhaust gas. Specifically, when the temperature of the exhaust gas is relatively low, it will result in a decrease in velocity at which NOx reacts with ammonia which leads to a decrease in efficiency of purification of the exhaust gas. Alternatively, when the temperature of the exhaust gas is relatively high, it will result in an increase in velocity at which NOx reacts with ammonia which decreases the possibility that the efficiency of purification of the exhaust gas is lowered.

In order to ensure the efficiency of purification of the exhaust gas without sacrificing the service life of the pump 18a, the urea SCR device of this embodiment is designed to control the pressure of the urea aqueous solution to be sprayed from the urea solution injector 15 as a function of the temperature of the exhaust gas. Specifically, when the temperature of the exhaust gas is low, that is, when it is expected that the velocity at which NOx reacts with ammonia has been lowered, meaning that the possibility that the efficiency of purification of the exhaust gas has been lowered is high, the SCR device works to elevate the pressure of the urea aqueous solution to be sprayed from the urea solution injector 15. Alternatively, when the temperature of the exhaust gas is high, that is, when it is expected that the velocity at which NOx reacts with ammonia is kept high, meaning that the possibility that the efficiency of purification of the exhaust gas has been lowered is low, the SCR device works to reduce the pressure of the urea aqueous solution to be sprayed from the urea solution injector 15.

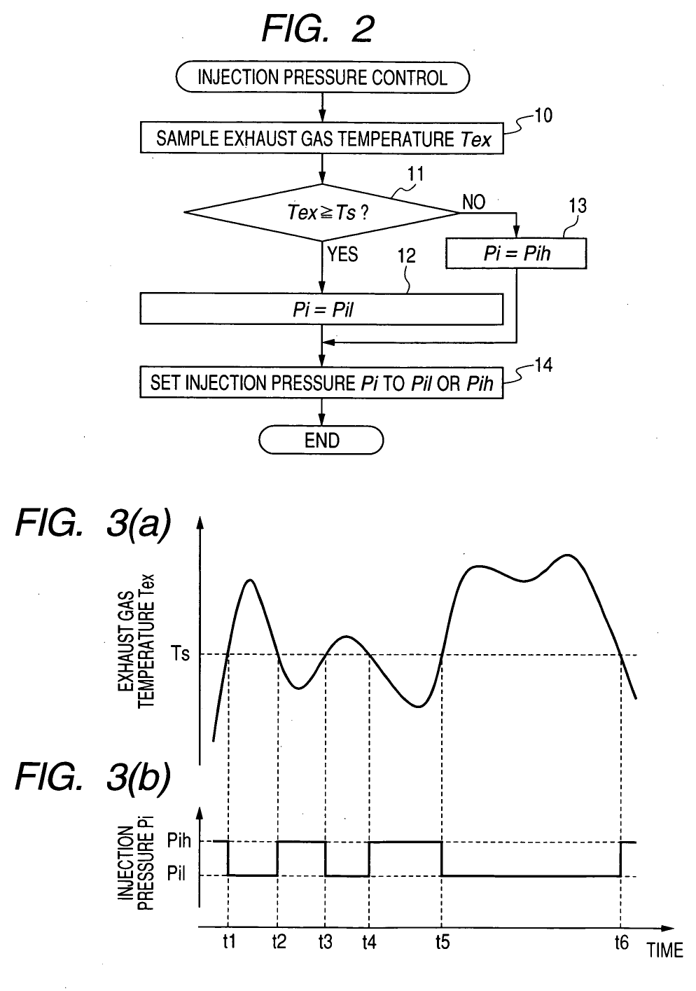

FIG. 2 is a flowchart of a sequence of logical steps or program to control the pressure of the urea aqueous solution to be sprayed from the urea solution injector 15. The program is executed by the ECU 20 each revolution of the crankshaft of the diesel engine through a preselcted angle to set the pressure Pi of the urea aqueous solution to be sprayed from the urea solution injector 15 to one of two discrete levels Pih and Pil (Pih>Pil) as a function of the temperature of the exhaust gas, as measured by the exhaust gas sensor 19.

After entering the program, the routine proceeds to step 10 wherein the temperature Tex of the exhaust gas is sampled. Specifically, the ECU 20 monitors an output from the exhaust gas temperature sensor installed in the exhaust gas sensor 19 and determines the temperature Tex of the exhaust gas.

The routine proceeds to step 11 wherein it is determined whether the temperature Tex is higher than or equal to a given threshold value Ts (e.g., 200° C.) or not. If a YES answer is obtained meaning that the temperature Tex of the exhaust gas is high, then the routine proceeds to step 12. Alternatively, if a NO answer is obtained, then the routine proceeds to step 13.

In step 12, the ECU 20 brings the injection pressure Pi of the urea aqueous solution into agreement with the lower level Pil. Specifically, when the temperature Tex of the exhaust gas is relatively higher, the ECU 20 sets the injection pressure Pi to the lower level Pil.

In step 13, the ECU 20 brings the injection pressure Pi of the urea aqueous solution into agreement with the higher level Pih. Specifically, when the temperature Tex of the exhaust gas is relatively lower, the ECU 20 sets the injection pressure Pi to the higher level Pih.

After step 12 or 13, the routine proceeds to step 14 wherein the ECU 20 controls the operation of the pump 18a to regulate the flow rate of the urea aqueous solution to be fed to the urea solution injector 15 so as to bring the injection pressure Pi into agreement with a selected one of the lower and higher levels Pil and Pih. Specifically, the ECU 20 samples an output from the urea solution pressure sensor 18d to determine the pressure Ps of the urea aqueous solution in the pipe 18b and controls the operation of the pump 18a so as to bring the pressure Ps into agreement with the injection pressure Pi (i.e., the higher or lower level Pih or Pil) in a feedback control mode. For example, when the pressure Ps is lower than the injection pressure Pi, the ECU 20 actuates the pump 18a at an increased power. Alternatively, when the pressure Ps is higher than or equal to the injection pressure Pi, the ECU 20 actuates the pump 18a at a decreased power.

The operation of the urea SCR device to control the injection pressure Pi through the execution of the program of FIG. 2 will be exemplified below with reference to FIGS. 3(a) and 3(b). FIG. 3(a) illustrates a change in the exhaust gas temperature Tex. FIG. 3(b) illustrates a change in the injection pressure Pi that is the pressure of the urea aqueous solution to be sprayed from the urea solution injector 15.

When the exhaust gas temperature Tex exceeds the threshold value Ts at time t1, the ECU 20 sets the injection pressure Pi of the urea aqueous solution to the lower level Pil, in other words, brings the pressure of urea aqueous solution to be outputted from the pump 18a into agreement with the lower level Pil. This results in a decrease in load on the pump 18a. When the exhaust gas temperature Tex drops below the threshold value Ts at time t2, the ECU 20 sets the injection pressure Pi of the urea aqueous solution to the higher level Pih, in other words, brings the pressure of urea aqueous solution to be outputted from the pump 18a into agreement with the higher level Pih. This enhances the atomization of the urea aqueous solution sprayed from the urea solution injector 15.

As apparent from the above discussion, the exhaust emission control system of this embodiment provide the following beneficial advantages.

When the temperature of the exhaust gas emitted from the diesel engine is lowered, it will cause the velocity at which NOx reacts with ammonia is decreased, so that the efficiency of purification of the exhaust gas is compromised. In such an event, the ECU 20 elevates the pressure of the urea aqueous solution to be sprayed from the urea solution injector 15 (see times t2 to t3 and times t4 to t5 in FIGS. 3(a) and 3(b)). This results in an increase in atomization of the urea aqueous solution to be sprayed from the urea solution injector 15 into the exhaust pipe 12 to enhance the velocity at which NOx reacts with ammonia, thereby ensuring the efficiency of purification of the exhaust gas in the urea SCR device.

Alternatively, when the temperature of the exhaust gas emitted from the diesel engine rises, it will result in an increase in velocity at which NOx reacts with ammonia, meaning that the possibility that the efficiency of purification of the exhaust gas has been compromised is low. In such an event, the ECU 20 decreases the pressure of the urea aqueous solution to be sprayed from the urea solution injector 15 (see times t1 to t2, times t3 to t4, and times t5 to t6 in FIGS. 3(a) and 3(b)). This results in a decrease in load on the pump 18a, thus ensuring the service life of the pump 18a.

The urea SCR device of the second embodiment will be described below.

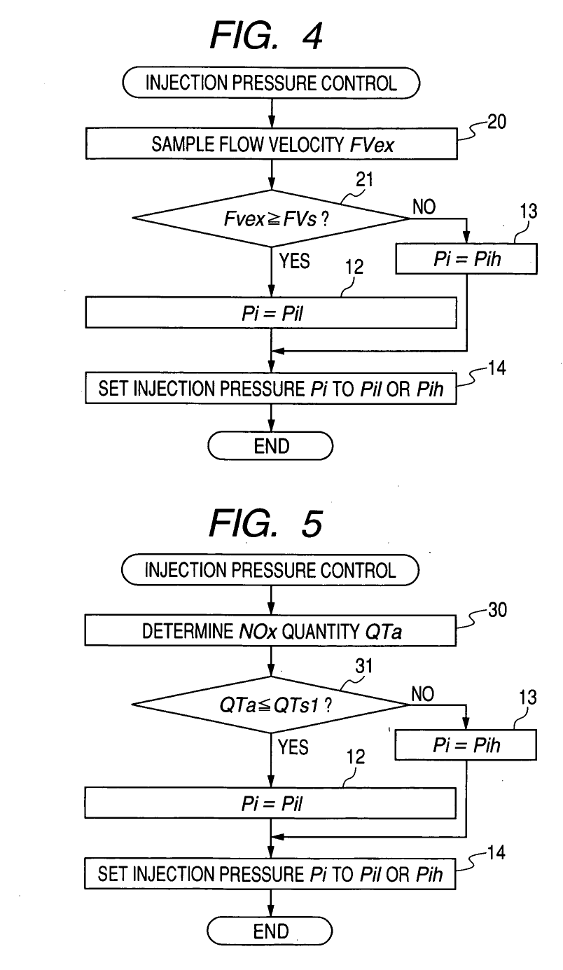

The ECU 20 of the urea SCR device of this embodiment is designed to control the injection pressure Pi of the urea aqueous solution as a function of the flow velocity (i.e., the flow rate) of the exhaust gas within the exhaust pipe of the diesel engine. This control task will be described below in detail with reference to a flowchart of FIG. 4. The same step numbers, as employed in FIG. 2, will refer to the same operations, and explanation thereof in detail will be omitted here.

After entering the program, the routine proceeds to step 20 wherein the flow velocity FVex of the exhaust gas emitted from the diesel engine is determined. The flow velocity FVex may be calculated using an output from the airflow meter 21.

The routine proceeds to step 21 wherein it is determined whether the flow velocity FVex is higher than or equal to a given threshold value FVs or not. If a YES answer is obtained meaning that the flow velocity FVex is higher than or equal to the threshold value FVs, then the routine proceeds to step 12. Alternatively, if a NO answer is obtained, then the routine proceeds to step 13.

In step 12, the ECU 20 sets the injection pressure Pi of the urea aqueous solution to the lower level Pil. In step 13, the ECU 20 sets the injection pressure Pi of the urea aqueous solution to the higher level Pih.

After step 12 or 13, the routine proceeds to step 14 wherein the ECU 20 controls the operation of the pump 18a to regulate the flow rate of the urea aqueous solution to be fed to the urea solution injector 15 so as to bring the injection pressure Pi into agreement with a selected one of the lower and higher levels Pil and Pih. Specifically, when the flow velocity FVex is lower than the given threshold value FVs, the ECU 20 actuates the pump 18a at an increased power. Alternatively, when the flow velocity FVex is higher than or equal to the given threshold value FVs, the ECU 20 actuates the pump 18a at a decreased power.

The spray of the urea aqueous solution charged by the urea solution injector 15 into the exhaust pipe 12 is further atomized by the flow of exhaust gas within the exhaust pipe 12. The degree of such atomization correlates to the flow velocity of the exhaust gas. Specifically, the atomization of the urea aqueous solution is enhanced as the flow velocity of the exhaust gas rises. Therefore, when it is expected that the degree of atomization of the urea aqueous solution is relatively low which leads to a decrease in efficiency of purification of the exhaust gas, the ECU 20 elevates the injection pressure of the urea aqueous solution to avoid such an efficiency decrease. Alternatively, when it is expected that the degree of atomization of the urea aqueous solution is relatively high, in other words, the atomization of the urea aqueous solution is enhanced by the flow of the exhaust gas to ensure the efficiency of purification of the exhaust gas, the ECU 20 decreases the injection pressure of the urea aqueous solution to reduce the load on the pump 18a in order to assure the service life of the pump 18a.

The flow velocity of the exhaust gas, as described above, may be calculated as a function of an output of the airflow meter 21 based on the fact that an increase in flow rate of intake air charged into the diesel engine will result in an increase in flow velocity (i.e., flow rate) of the exhaust gas emitted from the diesel engine.

The urea SCR device of the third embodiment will be described below.

The ECU 20 of the urea SCR device of this embodiment is designed to control the injection pressure Pi of the urea aqueous solution as a function of the quantity of NOx contained in the exhaust gas after cleaned by the SCR catalyst 13. This control task will be described below in detail with reference to a flowchart of FIG. 5.

After entering the program, the routine proceeds to step 30 wherein the quantity QTa of NOx contained in the exhaust gas flowing downstream of the SCR catalyst 13 is determined.

The routine proceeds to step 31 wherein it is determined whether the quantity QTa of NOx, as derived in step 30, is smaller than or equal to a threshold value QTs1 or not. If a YES answer is obtained meaning that the quantity QTa of NOx is smaller than or equal to the threshold value QTs1, then the routine proceeds to step 12 wherein the ECU 20 sets the injection pressure Pi of the urea aqueous solution to the lower level Pil. Alternatively, if a NO answer is obtained, then the routine proceeds to step 13 wherein the ECU 20 sets the injection pressure Pi of the urea aqueous solution to the higher level Pih.

After step 12 or 13, the routine proceeds to step 14 wherein the ECU 20 controls the operation of the pump 18a to regulate the flow rate of the urea aqueous solution to be fed to the urea solution injector 15 so as to bring the injection pressure Pi into agreement with a selected one of the lower and higher levels Pil and Pih.

The quantity of NOx contained in the exhaust gas emerging from the SCR catalyst 13 is found to indicate the degree of ability to purify the exhaust gas. Specifically, when such a purification ability is reduced, an increase in quantity of NOx contained in the exhaust gas before purified will result in an increase in that of the exhaust gas after purified. Accordingly, when the quantity of NOx staying in the exhaust gas having passed through the SCR catalyst 13 is great undesirably, the ECU 20 determines that the ability of purification of the exhaust gas has been reduced and elevates the injection pressure of the urea aqueous solution to ensure the stability of purification of the exhaust gas. Alternatively, when the quantity of NOx staying in the exhaust gas having passed through the SCR catalyst 13 is small desirably, the ECU 20 determines that the ability of purification of the exhaust gas is not reduced and decreases the injection pressure of the urea aqueous solution to reduce the load on the pump 18a, thereby assuring the service life of the pump 18a.

The quantity of NOx contained in the exhaust gas after purified may be calculated as a function of an output from the NOx sensor installed in the exhaust gas sensor 19.

The urea SCR device of the fourth embodiment will be described below.

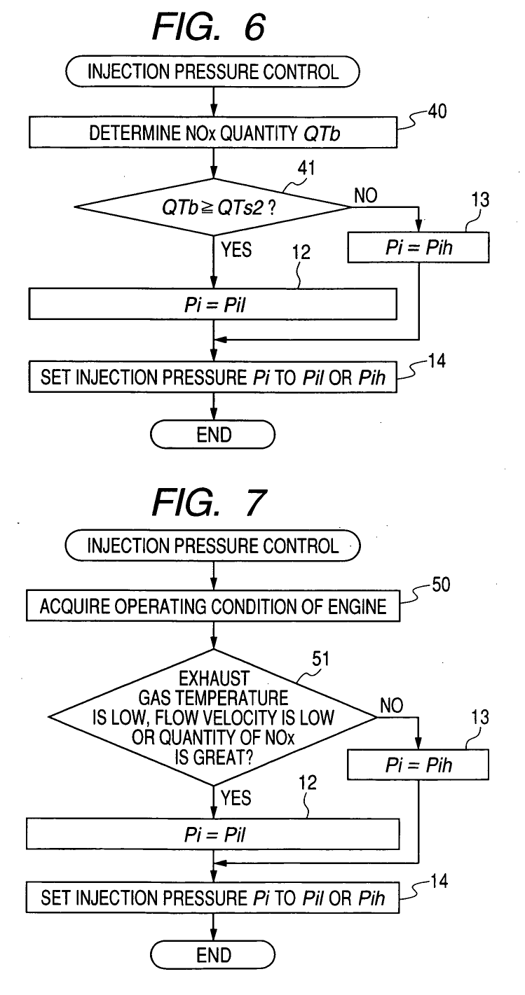

The ECU 20 of the urea SCR device of this embodiment is designed to control the injection pressure Pi of the urea aqueous solution as a function of the quantity of NOx contained in the exhaust gas before cleaned by the SCR catalyst 13. This control task will be described below in detail with reference to a flowchart of FIG. 6.

After entering the program, the routine proceeds to step 40 wherein the quantity QTb of NOx contained in the exhaust gas flowing upstream of the SCR catalyst 13 is determined.

The routine proceeds to step 41 wherein it is determined whether the quantity QTb of NOx, as derived in step 40, is smaller than or equal to a threshold value QTs2 or not. If a YES answer is obtained meaning that the quantity QTb of NOx is smaller than or equal to the threshold value QTs2, then the routine proceeds to step 12 wherein the ECU 20 sets the injection pressure Pi of the urea aqueous solution to the lower level Pil. Alternatively, if a NO answer is obtained, then the routine proceeds to step 13 wherein the ECU 20 sets the injection pressure Pi of the urea aqueous solution to the higher level Pih.

After step 12 or 13, the routine proceeds to step 14 wherein the ECU 20 controls the operation of the pump 18a to regulate the flow rate of the urea aqueous solution to be fed to the urea solution injector 15 so as to bring the injection pressure Pi into agreement with a selected one of the lower and higher levels Pil and Pih.

When the quantity of NOx contained in the exhaust gas before purified by the SCR catalyst 13 increases, the ability to purify the exhaust gas will be insufficient. Accordingly, when the quantity of NOx in the exhaust gas before purified is greater, the ECU 20 elevates the injection pressure of the urea aqueous solution to enhance the stability of purification of the exhaust gas. Alternatively, when the quantity of NOx contained in the exhaust gas before purified is smaller, the ECU 20 decreases the injection pressure of the urea aqueous solution to reduce the load on the pump 18a, thereby assuring the service life of the pump 18a.

The quantity of NOx in the exhaust gas before purified may be calculated as a function of the concentration of oxygen (O₂) in the exhaust gas or a parameter indicating the load on the diesel engine such as the amount of intake air or the position of the accelerator pedal. A NOx sensor may be installed in the exhaust pipe 12 upstream of the SCR catalyst 13 to directly measure the quantity of NOx in the exhaust gas before purified.

The urea SCR device of the fifth embodiment will be described below.

The ECU 20 of the urea SCR device of this embodiment is designed to control the injection pressure Pi of the urea aqueous solution based on an operating condition of the diesel engine. This control task will be described below in detail with reference to a flowchart of FIG. 7.

After entering the program, the routine proceeds to step 50 wherein the operating condition of the diesel engine is determined.

The routine proceeds to step 51 wherein it is determined whether the operating condition, as derived in step 50, indicates at least one of facts that the temperature of the exhaust gas is low, that the flow velocity of the exhaust gas is low, and that the quantity of NOx in the exhaust gas is great or not. Specifically, the determination in step 51 may correspond to any one of the determinations in step 11, 21, 31, and 41. If a NO answer is obtained meaning that the operating condition of the diesel engine does not indicate any of the above facts, the routine proceeds to step 12 wherein the ECU 20 sets the injection pressure Pi of the urea aqueous solution to the lower level Pil. Alternatively, if a NO answer is obtained, then the routine proceeds to step 13 wherein the ECU 20 sets the injection pressure Pi of the urea aqueous solution to the higher level Pih.

For example, when the diesel engine is being warmed up or continues to idle for a prolonged period of time, it will result in decreases in temperature and flow velocity of the exhaust gas. In such an event, the ECU 20 sets the injection pressure Pi of the urea aqueous solution to the higher level Pih. The operating condition of the diesel engine may be determined based on an output from the airflow meter 21, the accelerator position sensor 22, the crank angel sensor 23, or the coolant temperature sensor 23.

After step 12 or 13, the routine proceeds to step 14 wherein the ECU 20 controls the operation of the pump 18a to regulate the flow rate of the urea aqueous solution to be fed to the urea solution injector 15 so as to bring the injection pressure Pi into agreement with a selected one of the lower and higher levels Pil and Pih.

In the first embodiment, the ECU 20 works to monitor the temperature of exhaust gas flowing downstream of the SCR catalyst 13, as measured by the exhaust gas sensor 19, to control the pressure of the urea aqueous solution to be sprayed from the urea solution injector 15. The exhaust gas sensor 19 may alternatively be installed upstream of the SCR catalyst 13 to control the pressure of the urea aqueous solution to be sprayed from the urea solution injector 15 based on the temperature of the exhaust gas flowing upstream of the SCR catalyst 13.

The temperature of the exhaust gas may alternatively be determined based on a physical quantity such as the quantity of fuel injected into the diesel engine, the degree of load on the diesel engine, or the speed of the diesel engine.

In the above embodiments, the control of the pressure of the urea aqueous solution to be sprayed from the urea solution injector 15 is made by regulating the quantity of the urea aqueous solution sucked into the pump 18a (i.e., the discharged pressure of the pump 18a) to control the flow rate of the urea aqueous solution delivered to the urea solution injector 15, but however, may be achieved by regulating the quantity of the urea aqueous solution to be returned back to the urea solution tank 17. This regulation may be accomplished by the ECU 20 to change the set value P1 used to determined whether the urea aqueous solution is to be returned to the urea solution tank 17 through the pipe 18b or not. Alternatively, a valve which is to be actuated by the ECU 20 may be used to open or close the urea solution pressure regulator 18c to control the quantity of the urea aqueous solution to be returned back to the urea solution tank 17.

In the above embodiments, the ECU 20 regulates the injection pressure Pi of the urea aqueous solution to be sprayed from the urea solution injector 15 to one of two levels: the higher and lower levels Pih and Pil based on an exhaust gas state parameter indicating the state of the exhaust gas, but however, may be designed to set the injection pressure Pi to one of three or more discrete levels or change it continuously as a function of the exhaust gas state parameter.

In the first embodiment, the adjustment of the injection pressure Pi is made based on the determination of whether the temperature Tex of the exhaust gas is greater than or equal to the threshold value Ts or not. In other words, the condition for setting the injection pressure Pi has no hysteresis, however, may have the hysteresis to minimize the number of times the injection pressure Pi is adjusted.

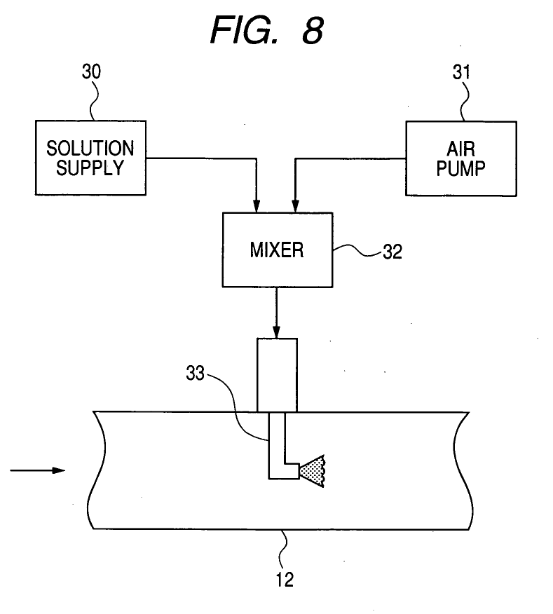

The urea SCR device may be designed to inject a spray of the additive (i.e., the urea aqueous solution) together with a pressurized gas into the exhaust pipe 12. FIG. 8 illustrates an example of such a structure. The urea SCR device includes a urea solution supplying device 30, an air pump 31, a mixer 32, and a nozzle 33. The ECU 20 actuates the urea solution supplying device 30 and the air pump 31 to supply the urea aqueous solution and compressed air to the mixture 32. The mixer 32 produces a mixture of the urea aqueous solution and the compressed air. The nozzle 33 sprays the urea solution-air mixture into the exhaust pipe 12.

The ECU 20 works to control the pressure of the compressed air, as produced by the air pump 31, as a function of the temperature or the flow velocity of the exhaust gas or the quantity of NOx contained in the exhaust gas to achieve the same beneficial effects, as described in the above embodiments, which ensure the efficiency in purifying the exhaust gas without sacrificing the service life of the air pump 31. The urea solution supplying device 30, the mixer 32, and the nozzle 33 serve as a urea solution injecting mechanism.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For instance, the present invention may alternatively be employed in exhaust emission control systems designed to purify exhaust emissions, as emitted from other than automotive engines, using a catalyst and an additive other than urea aqueous solution.

What is claimed is:

1. A reducing agent spray control system designed to control an operation of an exhaust emission control device which includes an injector working to inject a spray of a reducing agent into an exhaust pipe of an internal combustion engine to reduce a selected component of exhaust gas to purify the exhaust gas and a pump working to regulate a pressure of the reducing agent to be sprayed by the injector, comprising:
exhaust gas state parameter acquiring means for acquiring an exhaust gas state parameter associated with a state of the exhaust gas flowing through the exhaust pipe; and
control means for controlling an operation of the pump so as to bring the pressure of the reducing agent to be sprayed by the injector into agreement with a target value, as determined based on the exhaust gas state parameter, to control the spray of the reducing agent.

2. A reducing agent spray control system as set forth in claim 1, wherein said exhaust gas state parameter acquiring means acquires a temperature of the exhaust gas as representing the exhaust gas state, and wherein said control means determines the target value based on the temperature of the exhaust gas.

3. A reducing agent spray control system as set forth in claim 1, wherein said exhaust gas state parameter acquiring means acquires a flow velocity of the exhaust gas as representing the exhaust gas state, and wherein said control means determines the target value based on the flow velocity of the exhaust gas.

4. A reducing agent spray control system as set forth in claim 1, wherein said exhaust gas state parameter acquiring means acquires a quantity of the selected component of the exhaust gas as representing the exhaust gas state, and wherein said control means determines the target value based on the quantity of the selected component of the exhaust gas.

5. A reducing agent spray control system as set forth in claim 1, wherein said exhaust gas state parameter acquiring means acquires an operating condition of the internal combustion engine, and wherein when the operating condition represents one of facts that the internal combustion engine is being warmed up and that the internal combustion engine continues to idle over a given period of time, said control means controls the operation of the pump so as to bring the pressure of the reducing agent to be sprayed by the injector into agreement with the target value.

6. A reducing agent spray control system as set forth in claim 1, wherein the selected component of the exhaust gas is a nitrogen oxide, and the reducing agent is one of urea aqueous solution and ammonia, and wherein the exhaust emission control device also includes a catalyst installed in the exhaust pipe downstream of the injector to facilitate a reduction reaction of the nitrogen oxide with the reducing agent.
